(19) United States
(12) Patent Application Publication
(10) Pub. No.: US 2025/0018703 A1
(43) Pub. Date: Jan. 16, 2025

(54) BARRIER LAMINATE FOR PACKAGING MATERIAL

(71) Applicant: Stora Enso OYJ, Helsinki (FI)

(72) Inventor: Sami-Seppo Ovaska, Lappeenranta (FI)

(73) Assignee: Stora Enso OYJ, Helsinki (FI)

(21) Appl. No.: 18/710,087

(22) PCT Filed: Nov. 10, 2022
(86) PCT No.: PCT/IB2022/060815

§ 371 Date: May 14, 2024

(30) Foreign Application Priority Data
Nov. 15, 2021 (SE) 2151390-8

(51) Int. Cl. B32B 29/00; B32B 7/12; B32B 37/12

(52) U.S. Cl. CPC B32B 29/005; B32B 7/12; B32B 37/1207; B32B 2037/1215; B32B 2255/12; B32B 2255/26; B32B 2255/28; B32B 2307/718; B32B 2307/7244; B32B 2307/7246; B32B 2307/748; B32B 2317/18

(57) ABSTRACT

The present invention relates to a barrier laminate comprising: a first cellulose substrate comprising highly refined cellulose fibers; a tie layer comprising a hot melt adhesive and a second cellulose substrate wherein the peeling strength between the second substrate and the tie layer is between 3-5 N. The present invention also relates to a method for manufacturing said barrier laminate.

### TECHNICAL FIELD

The present disclosure relates to a barrier laminate having good recyclability and barrier properties. The laminate can be useful as paper or paperboard based packaging materials. More specifically, the present disclosure relates to a barrier laminate comprising one cellulose substrate comprising highly refined fibers, a tie layer comprising a hot melt adhesive and a second cellulose substrate. The present invention further relates to a method for producing said barrier laminate.

### BACKGROUND

Effective gas, aroma and/or moisture barriers are required in packaging industry for shielding sensitive products. Particularly, oxygen-sensitive products require an oxygen barrier to extend their shelf-life. Oxygen-sensitive products include many food products, but also pharmaceutical products and electronic industry products. Known packaging materials with oxygen barrier properties may be comprised of one or several polymer films or of a fibrous paper or board coated with one or several layers of an oxygen barrier polymer, usually as part of a multilayer coating structure. Another important property for packaging for food products is resistance to grease and oil.

More recently, microfibrillated cellulose (MFC) films have been developed, in which defibrillated cellulosic fibrils have been suspended e.g. in water, reorganized and rebonded together to form a continuous film. MFC films have been found to provide good gas barrier properties as well as good resistance to grease and oil. However, the gas barrier properties of such MFC films tend to deteriorate at high temperatures and high humidity.

Many approaches for improving the gas barrier properties towards oxygen, air, and aromas at high relative humidity have been investigated and described, but most of the suggested solutions involving chemical modification or polymer coating are expensive and difficult to implement in industrial scale.

Another challenge with barrier laminates for packaging industry is the recyclability of the laminates since they are composed of different type of materials, such as both paperboard and polymer layers. It is difficult to separate the barrier layers from the paperboard in order to recycle and reuse the fibers of the paperboard and the material of the barrier layers. There are different ways to solve this issue, e.g. addition of silicon to facilitate the removal of the layers from each other. However, addition of silicon leads to increased costs and a more complex material and process.

There is thus a need to find other ways to both improve the barrier properties and the recyclability properties of a barrier laminate comprising highly refined fibers or microfibrillated cellulose.

### DESCRIPTION OF THE INVENTION

It is an object of the present disclosure to provide a barrier laminate comprising highly refined microfibrillated cellulose, which has improved barrier properties, especially at high humidity.

It is an object of the present disclosure to provide an alternative to the conventional plastic films and aluminum foils commonly used as barrier films in packaging materials, such as liquid packaging board.

It is a further object of the present disclosure, to provide a biobased barrier laminate, which has improved barrier properties towards oxygen, water vapor and grease.

It is a further object of the present disclosure to provide a barrier laminate for paper or paperboard based packaging materials and liquid packaging board, which facilitates recycling of the paper or paperboard based packaging material as compared to packaging materials comprising plastic films or aluminum foils as barrier films.

The above mentioned objects, as well as other objects as will be realized by the skilled person in the light of the present disclosure, are achieved by the various aspects of the present disclosure.

According to a first aspect illustrated herein, there is provided a barrier laminate comprising: a first cellulose substrate comprising highly refined cellulose fibers; a tie layer comprising a hot melt adhesive and a second cellulose substrate wherein the peeling strength between the second substrate and the tie layer is between 3-5 N.

It was surprisingly found that it is possible to use a hot melt adhesive as a tie layer between the cellulose substrates to provide a barrier laminate having very good barrier properties. It was found that the tie layer comprising a hot melt adhesive increased the barrier properties, such as the WTR and OTR value of the film even at high humidity. Furthermore, it was found that the recyclability of the barrier laminate was very good, i.e. it was possible to separate the tie layer from the seconds cellulose substrate. In this way the separation and thus also the recyclability properties of the laminate are strongly improved.

The tie layer comprises a hot melt adhesive, it may be preferred that the tie layer consists of the hot melt adhesive. A hot melt adhesive is a material that softens/melts to a liquid in heat and then hardens again when cooled. Different hot melt adhesives have different melting temperatures. It is important to use a hot melt adhesive that melts at temperatures below 230° C., preferably at a temperature between 80-230° C., otherwise the cellulose substrate may be damaged due to the high temperature use.

Another advantage with the use of a hot melt adhesive when making a barrier laminate is that no water is added. Cellulose substrate, especially barrier films comprising highly refined fibers or microfibrillated cellulose are very sensitive to moisture and water and addition of too much water to the substrate may strongly decrease the barrier properties of the substrate due to problem with dimensional stability and shrinkage of the substrate. By using a hot melt adhesive, it was found that both excellent adhesive properties between the tie layer and cellulose substrate was formed but also that the barrier properties of the cellulose substrate were not negatively affected at the same time as the recyclability of the laminate was improved.

It is preferred that the tie layer is arranged between the first and second cellulose substrate.

The first cellulose substrate may be comprised solely of highly refined fibers or MFC, or it can comprise a mixture of highly refined fibers, MFC and other ingredients or additives. The first cellulose substrate of the inventive barrier laminate preferably includes highly refined fibers or MFC as its main component based on the total dry weight of the substrate. In some embodiments, the substrate comprises at least 50 wt %, preferably at least 70 wt %, more preferably at least 80 wt % of highly refined fibers or MFC, based on the total dry weight of the cellulose substrate.

The basis weight of the first cellulose substrate comprising high amounts of highly refined fibers or MFC of the inventive barrier laminate is preferably in the range of less than 55 gsm (grams per square meter). The basis weight of the cellulose substrate may for example depend on the mode of its manufacture. For example, coating of a suspension onto a substrate may result in a thinner layer, whereas the formation of a free-standing laminate for lamination to a substrate may require a thicker layer. In some embodiments, the basis weight of the first and/or second cellulose substrate is in the range of 5-50 gsm. In some embodiments, the basis weight of the first cellulose substrate layer is in the range of 5-35 gsm.

It is preferred that the first cellulose substrate comprising at least 50% of highly refined fibers or MFC is in the form of a barrier film. The barrier film preferably has an oxygen transmission rate (OTR), measured according to the standard ASTM F-1927 at 50% relative humidity and 23° C., of more than 50 cc/m²/24 h/atm, preferably between 50-200 cc/m²/24 h/atm. It has been found that it is possible to use a barrier film with deteriorated barrier properties and still be able to produce a barrier laminate with very good barrier properties.

The term film as used herein refers generally to a thin continuous sheet formed material. Depending on the composition of the pulp suspension, the film can also be considered as a thin paper or even as a membrane. The film may also comprise more than one layer, i.e. a multilayer film. The multilayer film is typically relatively dense. In some embodiments, the multilayer film has a density above 600 kg/m³, preferably above 900 kg/m³.

The cellulose fibers of the first and/or second cellulose substrate is preferably cellulosic fibers from softwood and/or hardwood.

Paper generally refers to a material manufactured in thin sheets from the pulp of wood or other fibrous substances comprising cellulose fibers, used for writing, drawing, or printing on, or as packaging material.

Paperboard generally refers to strong, thick paper or cardboard comprising cellulose fibers used for boxes and other types of packaging. Paperboard can either be bleached or unbleached, coated or uncoated, and produced in a variety of thicknesses, depending on the end use requirements. The paper or paperboard can comprise softwood and/or hardwood cellulose fibers. It can be produced from chemical pulp, chemi-thermomechanical pulp (CTMP) and or mechanical pulp.

The second cellulose substrate may be a paper or paperboard substrate. It is preferred that the paper or paperboard substrate has a basis weight in the range of 20-500 g/m², preferably in the range of 80-400 g/m². The barrier laminate according to one embodiment may comprise a first cellulose substrate comprising high amounts of highly refined cellulose or MFC that is the form of a film, a tie layer comprising a hot melt adhesive and a second cellulose substrate in form of a paper or paperboard substrate. The second substrate in the form of a paper or paperboard substrate may also be pigment coated on one or both sides. The pigment may for example be selected from the group consisting of CaCO₃ (such as PCC or GCC), clay (such as kaolin or calcined kaolin), TiO2, talcum, plastic pigments, Al₂O₃, SiO₂, or a nano-pigments such as bentonite, or a mixture thereof. In preferred embodiments the pigment is selected from the group consisting of CaCO₃ and clay or a mixture thereof.

The hot melt adhesive is preferably a thermoplastic resin, such as ethylene vinyl acetate (EVA), ethylene-acrylate, polyisobutylene and/or thermoplastic polyurethane. The thickness of the tie layer is preferably between 3-100 μm, preferably between 5-60 μm, even more preferred between 5-35 μm. It is preferred that the hot melt adhesive is biobased in order to be able to produce a sustainable barrier laminate. The hot melt adhesive may also comprise additives. It may be preferred to add cellulosic fibers or microfibrillated cellulose in order to further improve the sustainability of the hot melt adhesive. The hot melt adhesive may comprise 1-50% by weight of MFC, preferably between 5-30% by weight of MFC. The hot melt adhesive may be added in one or more layers.

With improved peelability properties is meant that the loss of fibers in the second cellulose substrate is less than 5% by weight after the tie layer and first cellulose substrate have been separated and removed. There is of course important as well that the adhesion between the first cellulose substrate, tie layer and second cellulose substrate is sufficient in order for the barrier laminate to be useful for many different end applications, such as packaging substrate, i.e. that the peeling strength is not too low.

The peel strength which is the force required to peel off layers of multiple laminate structures was measured with an Alwetron TCT 5 (Alwetron peel test). The sample has a width of 2.54 cm and a length of about 15 cm. A two-sided adhesive tape was attached to the sample. The tape had a width of 2.5 cm and were about 2 cm longer than the sample. The sample was attached to the jaws of the Alwetron equipment and the release angle used was 125°. The Alwetron was equipped with a 500 N sensor and the peeling speed used was 3.6 mm/s. The peel force is measured in the unit N.

It is preferred that the first cellulose substrate and tie layer is composted, and the second cellulose substrate is recycled in order to reuse the fibers of the second cellulose substrate.

The barrier laminate preferably has a water vapor transfer rate (WVTR), measured according to the standard ISO 15106-2/ASTM F1249 at 50% relative humidity and 23° C., of less than 50 g/m²/24 h, preferably less than 25 g/m²/24 h and even more preferred below 10 g/m²/24 h.

The barrier laminate preferably has an oxygen transmission rate (OTR), measured according to the standard ASTM F-1927 at 50% relative humidity and 23° C., of less than 20 cc/m²/24 h/atm, preferably less than 10 cc/m²/24 h/atm. The laminate according to the invention has shown to have very good barrier properties.

The barrier laminate will typically exhibit good resistance to grease and oil. Grease resistance of the barrier film is evaluated by the KIT-test according to standard ISO 16532-2. The test uses a series of mixtures of castor oil, toluene and heptane. As the ratio of oil to solvent is decreased, the viscosity and surface tension also decrease, making successive mixtures more difficult to withstand. The performance is rated by the highest numbered solution which does not darken the film sheet after 15 seconds. The highest numbered solution (the most aggressive) that remains on the surface of the paper without causing failure is reported as the “kit rating” (maximum 12). In some embodiments, the KIT value of the barrier film is at least 8, preferably at least 10, as measured according to standard ISO 16532. The oil and grease resistance (OGR) can also be measured with a chicken fat-method by the standard ASTM F119-8 at 60° C. It was found that the barrier laminate according to the invention has a very good barrier against grease and can then be used in direct food contact packages. It is an advantage to be able to separate the first cellulose substrate and tie layer from the second cellulose substrate since grease that might have penetrated into the first substrate and tie layer can be easily removed. It is not desirable to have grease or other food contamination components with the cellulose fibers of the seconds cellulose substrate since the end use of such recycled fibers will be very limited.

The second substrate preferably do not comprise any silicone, either as an additive in the substrate or added as a layer on the surface of the second substrate. It was found that the use hot melt adhesive will give very good peelability properties so it is not necessary to use any silicone layer or additives in order for the tie layer and first substrate to be peelable from the second substrate.

The second cellulose substrate preferably has a lower surface energy value than the tie layer and the first cellulose substrate, preferably a value below 40 mN/m measured according to ASTM D7490. It is preferred that the second cellulose substrate has a surface energy value below 35, preferably between 20-35. The tie layer and the first cellulose substrate preferably has a similar surface energy value, preferably a value above 40 mN/m measured according to ASTM D7490. It is preferred that the tie layer and the first cellulose substrate has a surface energy value above 45, preferably between 45-55. It is preferred that the surface energy value of the tie layer and first cellulose substrate do not differ more than 10%, preferably less than 5% from each other. It has been found that the peelability properties of the barrier laminate is improved if the surface energy of the different layers of the laminate is as mentioned above.

It may be preferred to add internal sizing agent to the second cellulose substrate to even further reduce the surface energy of the second cellulose substrate and thus also the peelabilty properties of the laminate. Preferred sizing agents are AKD, ASA and/or rosin sizing. The amount of sizing added to the second cellulose substrate is preferably between 0.2-5 kg/t, preferably between 0.3-3 kg/t.

The first and/or second substrate may further comprise additives such as native starch or starch derivatives, cellulose derivatives such as sodium carboxymethyl cellulose, a filler, retention and/or drainage chemicals, flocculation additives, deflocculating additives, dry strength additives, softeners, cross-linking aids, sizing chemicals, dyes and colorants, wet strength resins, fixatives, de-foaming aids, microbe and slime control aids, or mixtures thereof. The first and/or second substrate may further comprise additives that will improve different properties of the mixture and/or the produced film such as latex and/or polyvinyl alcohol (PVOH) for enhancing the ductility of the film.

The term highly refined cellulose fibers as used herein refers to a cellulose fibers which have been subjected to considerable refining, but not to the extent that all of the cellulose fibers will pass through a 200 mesh screen (equivalent hole diameter 76 μm) of a conventional laboratory fractionation device (SCAN-CM 66:05). The term highly refined cellulose pulp as used herein refers to a cellulose pulp having a Schopper-Riegler (SR) number above 65, and preferably in the range of 70-90, as determined by standard ISO 5267-1.

Microfibrillated cellulose (MFC) shall in the context of the patent application mean a cellulose particle, fiber or fibril having a width or diameter of from 20 nm to 1000 nm. It is preferred that the microfibrillated cellulose has a SR of 85 or higher, as determined by standard ISO 5267-1.

Various methods exist to make MFC, such as single or multiple pass refining, pre-hydrolysis followed by refining or high shear disintegration or liberation of fibrils. One or several pre-treatment steps is usually required in order to make MFC manufacturing both energy efficient and sustainable. The cellulose fibers of the pulp used when producing MFC may thus be native or pre-treated enzymatically or chemically, for example to reduce the quantity of hemicellulose or lignin. The cellulose fibers may be chemically modified before fibrillation, wherein the cellulose molecules contain functional groups other (or more) than found in the original cellulose. Such groups include, among others, carboxymethyl (CM), aldehyde and/or carboxyl groups (cellulose obtained by N-oxyl mediated oxidation, for example “TEMPO”), or quaternary ammonium (cationic cellulose). After being modified or oxidized in one of the above-described methods, it is easier to disintegrate the fibers into MFC.

MFC can be produced from wood cellulose fibers, both from hardwood or softwood fibers. It can also be made from microbial sources, agricultural fibers such as wheat straw pulp, bamboo, bagasse, or other non-wood fiber sources. It can be made from pulp, including pulp from virgin fiber, e.g. mechanical, chemical and/or thermomechanical pulps. It can also be made from broke or recycled paper.

The barrier laminate may also comprise at least one polymer layer. The polymer layer is applied on at least one surface of the first and/or second cellulose substrate. The polymer layer may comprise any of the polymers commonly used in paper or paperboard based packaging materials in general or polymers used in liquid packaging board in particular. Examples include polyethylene (PE), polyethylene terephthalate (PET), polypropylene (PP) and polylactic acid (PLA). Polyethylene, especially low density polyethylene (LDPE), linear low density polyethylene (LLDPE) and high density polyethylene (HDPE), are the most common and versatile polymers used in liquid packaging board. It is preferred to only add polymer to one side of the second cellulose substrate, preferably to the side of the substrate where no tie layer is added.

In some embodiments, the polymer layer is formed by extrusion coating of the polymer onto the at least one surface of the cellulose substrate. Extrusion coating is a process by which a molten plastic material is applied to a substrate, such as paper or paperboard to form a very thin, smooth and uniform layer. The coating can be formed by the extruded plastic itself, or the molten plastic can be used as an adhesive to laminate a solid plastic film onto the substrate. Common plastic resins used in extrusion coating include polyethylene (PE), polypropylene (PP), polyhydroxyalkanoates (PHA), polylactic acid (PLA), polyvinyl alcohol (PVOH), polyglycolic acid (PGA) and polyethylene terephthalate (PET).

According to a second aspect illustrate herein, there is provided a method for manufacturing a barrier laminate comprising the steps of: providing a first cellulose substrate comprising highly refined fibers, providing a second cellulose substrate, applying a tie layer comprising a hot melt adhesive between said first and said second cellulose substrate to form said laminate wherein the peeling strength between the second substrate and the tie layer is between 3-5 N.

It is preferred that the tie layer is applied by extrusion coating, lamination, slot die coating, rod coating, curtain coating, anilox, rotogravure, spraying, off set and/or blade coating. Consequently, it is possible to coat or spray the hot melt adhesive onto the surface of the first and/or second cellulose substrate, followed by attaching the first and second substrate together to form said tie layer between the substrates and to form the barrier laminate. It is also possible that the hot melt adhesive is provided in the form of a laminate. The hot melt adhesive is the applied between the substrates and heat is thereafter applied for the hot melt adhesive to melt and form said tie layer, i.e. hot lamination process. The preferred temperature of the surface of substrate to which the hotmelt adhesive is applied is preferably above 50° C., even more preferred above 60° C. and most preferred above 70° C. It may be preferred to apply a pressure to the laminate after the hot melt adhesive has been applied, e.g. by using any normal pressing equipment well familiar to a person skilled in the art. The hot melt adhesive will be cooled down during and/or after attaching the two substrates together. After cooling down the hot melt adhesive will return to solid form and ensure good adhesion of the substrates and prevent the laminate from delamination problems. The tie layer preferably has a thickness of between 3-100 μm, preferably between 5-60 μm.

### EXAMPLES

### Example 1

### Materials

Paperboard with a grammage of 310 gsm that has been coated with PE 15 gsm
MFC film comprising MFC with a SR value of 97 (measure according to ISO 5267-1). The thickness of the film was 31 μm and it has a grammage of 27-28 gsm.
EVA-based hot melt adhesive

### Methods

### Sample Preparation:

Hot melt adhesive was applied on top of the uncoated side (not PE coated side) of the paperboard
The hot adhesive was doctored with a plastic blade to create a thin layer
The MFC film was placed immediately after doctoring on top of the glued paperboard
The laminate was thereafter pressed together mechanically

### Barrier Test:

WTR was measured at 23° C. and RH 50% according to ISO 15106-2.
OTR was measured at 23° C. and RH 50% according to ASTM F-1927.
KIT was measured according to ISO 16532.

### Thickness of the Adhesive Layer:

Optical microscopy of the cross-sections
Magna-Mike 8600 thickness measurement

### Results

### WTR Values:

Paperboard: 6.9±0.07 g/m²/24 h
Paperboard+hot melt adhesive: 5.2±0.07 g/m²/24 h
Paperboard+hot melt adhesive+MFC film: 5.2±0.42 g/m²/24 h
MFC film: 14.5±0.71 g/m²/24 h

### OTR Values:

Paperboard: OTR over detection limit, i.e. >2000 cc/m²/24 h/atm
Paperboard+hot melt adhesive: OTR over detection limit, i.e. >2000 cc/m²/24 h/atm
Paperboard+hot melt adhesive+MFC film: 16 cc/m²/24 h/atm

### KIT Value:

Paperboard+hot melt adhesive+MFC film: 12

### Thickness of the Adhesive Layer: 60-90 μm

### Example 2

### Materials

Same materials as in example 1 were tested.

Peeling tests were done using Alwetron TCT 5 tester equipped with the 500 N sensor. The width of the test strip was 25.4 mm and peeling speed was 3.6 mm/s. Drawing length varied between 40-60 mm depending on sample.

Based on the tests done, the following observations were made:
Samples that had decent adhesion, but the film was still separable, had a peeling force of 3.5-4.8 N
If peeling force was ˜4.5 N, the risk of film rupture during drawing increased
Peeling force greater than 5.2 N led to film rupture without an exemption
If peeling force was 2.5 N or less, the separation of film was “too easy”, i.e. the adhesion was without a doubt too low for real-life end use applications
It can thus be said that the optimal peeling strength was 3.5-4.5 N in case of this material combination
It was found that less than 5% of the fibers in the board layer remained on the tie layer after separation in the successful cases.

### Summary of Examples

It was found that the use of hot melt adhesive strongly improved the WTR values of the barrier laminate. The combination of the MFC film still gives the same good WTR values but we also see improved OTR values of the barrier laminate. It was also found possible to separate the tie layer from the paperboard in a very good way.

Consequently, it was found possible to produce a barrier laminate having very good WVTR, OTR and KIT values according to the present invention at the same time as it has very good recyclability properties.

While the invention has been described with reference to various exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A barrier laminate comprising:
a first cellulose substrate comprising highly refined cellulose fibers,
a tie layer comprising a hot melt adhesive, and
a second cellulose substrate, wherein a peeling strength between the second substrate cellulose and the tie layer is between 3-5 N.

2. The barrier laminate according to claim 1, wherein the tie layer is arranged between the first cellulose substrate and the second cellulose substrate.

3. The barrier laminate according to claim 1, wherein the first cellulose substrate comprises at least 50 wt % of highly refined cellulose fibers, based on a total dry weight of the first cellulose substrate.

4. The barrier laminate according to claim 1, wherein the highly refined cellulose fibers have a SR value of 65 or higher, as determined by standard ISO 5267-1.

5. The barrier laminate according to claim 1, wherein the highly refined fibers comprise microfibrillated cellulose with a SR of 85 or higher, as determined by standard ISO 5267-1.

6. The barrier laminate according to claim 1, wherein a basis weight of the first cellulose substrate is in the a range of 55 gsm or less.

7. The barrier laminate according to claim 1, wherein the first cellulose substrate is a barrier film.

8. The barrier laminate according to claim 1, wherein the hot melt adhesive is a thermoplastic resin, such as ethylene vinyl acetate (EVA), ethylene-acrylate, polyisobutylene and/or thermoplastic polyurethane.

9. The barrier laminate according to claim 1, wherein a thickness of the tie layer is between 3-100 μm.

10. The barrier laminate according to claim 1, wherein the second cellulose substrate is a paper or paperboard substrate.

11. The barrier laminate according to claim 10, wherein the second cellulose substrate comprises a paper or paperboard substrate having a basis weight in a range of 20-500 g/m².

12. The barrier laminate according to claim 1, wherein the laminate has an oxygen transmission rate (OTR), measured according to the standard ASTM F-1927 at 50% relative humidity and 23° C., of less than 20 cc/m²/24 h/atm.

13. The barrier laminate according to claim 1, wherein the laminate has a water vapor transfer rate (WVTR), measured according to the standard ISO 15106-2/ASTM F1249 at 50% relative humidity and 23° C., of less than 50 g/m²/24 h.

14. The barrier laminate according to claim 1, wherein the barrier laminate has a KIT value of at least 8, as measured according to standard ISO 16532.

15. The barrier laminate according to claim 1, wherein the second cellulose substrate has a lower surface energy value than the tie layer and the first cellulose substrate.

16. The barrier laminate according to claim 1, wherein the tie layer and the first cellulose substrate has a similar surface energy value.

17. The barrier laminate according to claim 1, wherein the second cellulose substrate comprises an internal sizing agent.

18. A method for manufacturing a barrier laminate comprising the steps of:
providing a first cellulose substrate comprising highly refined fibers,
providing a second cellulose substrate,
applying a tie layer comprising a hot melt adhesive between said first cellulose substrate and said second cellulose substrate to form said laminate,
wherein a peeling strength between the second cellulose substrate and the tie layer is between 3-5 N.

19. The method according to claim 18, wherein the tie layer is applied by extrusion coating, lamination, slot die coating, rod coating, curtain coating, anilox, rotogravure, spraying, off set, blade coating, or any combination thereof.

20. The method according to claim 18, wherein the tie layer has a thickness of between 3-100 μm.

21. The method according to claim 18, wherein the hot melt adhesive comprises a thermoplastic resin.

22. The method according to claim 18, wherein the first cellulose substrate comprises at least 50 wt % of highly refined cellulose fibers, based on the total dry weight of the first substrate.

23. The method according to claim 18, wherein a basis weight of the first cellulose substrate is in a range of 55 gsm or less.

24. The method according to claim 18, wherein the first cellulose substrate is a barrier film.

25. The method according to claim 18, wherein the second cellulose substrate is a paper or paperboard substrate.

26. The method according to claim 18, wherein the second cellulose substrate has a lower surface energy value compared to the tie layer and the first cellulose substrate.

27. The method according to claim 18, wherein the tie layer and the first cellulose substrate have a similar surface energy value.
